(19) United States
(12) Patent Application Publication
(10) Pub. No.: US 2022/0026219 A1
(43) Pub. Date: Jan. 27, 2022

(54) WALKING ROUTE DETERMINATION UNIT, METHOD, AND PROGRAM

(71) Applicant: NIPPON TELEGRAPH AND TELEPHONE CORPORATION, Tokyo (JP)

(72) Inventors: Keihiro OCHIAI, Tokyo (JP); Hirofumi ABE, Tokyo (JP); Hitoshi SESHIMO, Tokyo (JP)

(73) Assignee: NIPPON TELEGRAPH AND TELEPHONE CORPORATION, Tokyo (JP)

(21) Appl. No.: 17/299,279

(22) PCT Filed: Nov. 21, 2019
(86) PCT No.: PCT/JP2019/045636

§ 371 Date: Jun. 2, 2021

(30) Foreign Application Priority Data
Dec. 5, 2018 (JP) 2018-228565

(51) Int. Cl. G01C 21/30; G01S 19/39; G08G 1/005

(52) U.S. Cl. CPC G01C 21/30; G08G 1/005; G01S 19/396

(57) ABSTRACT

To accurately determine walking routes with roadways interposed therebetween. An environmental value calculation unit (18) calculates, based on a plurality of satellite signals from a plurality of satellites received by a positioning apparatus held by a pedestrian of object, an environmental value indicating whether a reception environment of a satellite signal of the plurality of satellite signals is good or bad for a left half side and a right half side with reference to a traveling direction of the pedestrian, and a route determination unit (20) compares an environmental value of the left half side calculated by the environmental value calculation unit (18) with an environmental value of the right half side calculated by the environmental value calculation unit (18) to determine a walking route of the pedestrian.

### TECHNICAL FIELD

The disclosed technologies relate to a walking route determination apparatus, method and program, and particularly to a walking route determination apparatus, method, and program for determining walking routes with roadways interposed therebetween.

### BACKGROUND ART

In the related art, there is a map-matching technique for matching positioning results based on satellite signals received from a satellite with a route network representing roadways, as a technique for route determination. This is a method of matching positioning results (the X marks in FIG. 23) with a link of a route network (the black circles and the dashed lines in FIG. 23) with the shortest distance as illustrated in FIG. 23, for example.

### CITATION LIST

### Non Patent Literature

Non Patent Literature 1: Mohammed A. Quddus, Washington Y. Ochieng, Robert B. Noland: “Current map-matching algorithms for transport applications: State-of-the art and future research directions”, Transportation Research Part C, Vol. 15, pp. 312 to 328, 2007.

### SUMMARY OF THE INVENTION

### Technical Problem

The example in FIG. 23 is a case in which a route is selected from a route network representing roadways, and if intervals between buildings are equal to or greater than 10 m with respect to an average error (10 m) of a positioning result, it is possible to match the positioning results to the route network without causing any serious problems.

However, in a case of determining one of sidewalks with roadways interposed therebetween as a walking route as illustrated in FIG. 24, it is necessary to determine which side of sidewalks disposed at 3 m of a minimum (1 lane) interval or 6 m of 2 lanes interval is walked on. This is difficult if an average error of a positioning result is taken into consideration. It is also known that in urban areas (urban canyons) with a lot of buildings, positioning errors are larger because a group of buildings form discontinuous spatial shapes and the radio waves from satellites are diffusely reflected therefrom, and thus this determination is more difficult.

In a case in which the technique in Non Patent Literature 1 described above is applied as it is to walking route determination including sidewalks with roadways interposed therebetween, it is assumed that a correctness rate of matching my deteriorate from about 80% to about 50%. This is because the positioning results are corrected based only on a relationship between the positioning results and the route network and the fact that the positioning accuracy drops significantly if a reception environment of radio waves from satellites deteriorates is not taken into consideration.

The disclosed technique was made in view of the aforementioned circumstances, and an object thereof is to provide walking route determination apparatus, method, and program capable of accurately determining walking routes with roadways interposed therebetween.

### Means for Solving the Problem

In order to achieve the aforementioned object, a walking route determination apparatus according to the disclosed technique is configured to include an environmental value calculation unit that calculates, based on a plurality of satellite signals from a plurality of satellites received by a positioning apparatus held by a pedestrian of object, an environmental value indicating whether a reception environment of a satellite signal of the plurality of satellite signals is good or bad for a left half side and a right half side with reference to a traveling direction of the pedestrian, and a route determination unit that compares an environmental value of the left half side calculated by the environmental value calculation unit with an environmental value of the right half side calculated by the environmental value calculation unit to determine a walking route of the pedestrian.

According to a walking route determination apparatus of the disclosed technique, an environmental value calculation unit calculates, based on a plurality of satellite signals from a plurality of satellites received by a positioning apparatus held by a pedestrian of object, an environmental value indicating whether a reception environment of a satellite signal of the plurality of satellite signals is good or bad for a left half side and a right half side with reference to a traveling direction of the pedestrian. Then, a route determination unit compares an environmental value of the left half side calculated by the environmental value calculation unit with an environmental value of the right half side calculated by the environmental value calculation unit to determine a walking route of the pedestrian.

In this way, because a walking route is determined taking advantage of the fact that based on the traveling direction of a pedestrian, the reception environment on the left half side is good when traveling on the right sidewalk across the roadway, and the reception environment on the right half side is good when traveling on the left sidewalk across the roadway and using an environmental value indicating whether the satellite signal reception environments on the left half side and the right half side based on the traveling direction of the pedestrian are good or bad, the walking route with roadways interposed therebetween can be accurately determined.

Also, the environmental value calculation unit can calculate the environmental value using a value indicating an amount of arrival of the satellite signal. In addition, the environmental value calculation unit can calculate the environmental value using a value indicating whether a line of sight of each of the plurality of satellites as seen from the pedestrian is good or bad. Because the amount of arrival of the satellite signal on the side facing buildings is lower, and the line of sight of the satellites deteriorates in an urban canyon surrounded by buildings, it is possible to use the aforementioned values as environmental values of the disclosed technique.

Also, the walking route determination apparatus according to the disclosed technique can be configured to further include a candidate calculation unit that calculates a first candidate and a second candidate of a walking route, which are positioned to face each other in relation to a roadway along the traveling direction of the pedestrian, through map-matching a position of the pedestrian measured at reception times based on the satellite signal received from each of the plurality of satellites to any of links configuring a walking route network, and the route determination unit can determine the walking route through map-matching the position of the pedestrian measured at each of the reception times to either the first candidate or the second candidate selected through comparison between the environmental value of the left half side and the environmental value of the right half side. In this manner, it is possible to more accurately determine the walking routes with roadways interposed therebetween.

Also, the walking route determination apparatus according to the disclosed technique can be configured to further include a traveling direction determination unit that determines the traveling direction of the pedestrian based on a sign of a calculated value based on an inner product of a direction of the positioning apparatus obtained from positioning results of the pedestrian at consecutive reception times and a direction of a link calculated as the first candidate or the second candidate. In this manner, accuracy of the traveling direction of the pedestrian is stabilized.

Also, the walking route determination apparatus according to the disclosed technique can be configured to further include a section determination unit that determines sections using, as a boundary, a timing at which links as the first candidate and the second candidate calculated by the candidate calculation unit change simultaneously, and the environmental value calculation unit can calculate the environmental value of the left half side and the environmental value of the right half side for each of the sections determined by the section determination unit, and the route determination unit can determine the walking route for each of the sections determined by the section determination unit. In this manner, it is possible to accurately determine sections and to determine a route for each of the sections determined with accuracy.

Also, a walking route determination method according to the disclosed technique is a method including, by an environmental value calculation unit, calculating, based on a plurality of satellite signals from a plurality of satellites received by a positioning apparatus held by a pedestrian of object, an environmental value indicating whether a reception environment of a satellite signal of the plurality of satellite signals is good or bad for a left half side and a right half side with reference to a traveling direction of the pedestrian, and, by a route determination unit, comparing an environmental value of the left half side calculated by the environmental value calculation unit with an environmental value of the right half side calculated by the environmental value calculation unit to determine a walking route of the pedestrian.

Also, a walking route determination program according to the disclosed technique is a program that causes a computer to operate as components configuring the aforementioned walking route determination apparatus.

### Effects of the Invention

As described above, according to the walking route determination apparatus, method, and program of the disclosed technique, it is possible to accurately determine walking routes with roadways interposed therebetween because the walking routes are determined using environmental values indicating whether the reception environments of satellite signals on the left half side and the right half side with reference to the traveling direction of the pedestrian are good or bad.

### BRIEF DESCRIPTION OF DRAWINGS

FIG. 1 is a diagram for explaining signal intensities of satellite signals from satellites in a case in which pedestrians are walking along sidewalks on the right side and the left side with roadways interposed therebetween.

FIG. 2 is a diagram for explaining whether the lines of sight of the satellites are good or bad in a case in which pedestrians are walking along sidewalks on the right side and the left side with roadways interposed therebetween.

FIG. 3 is a functional block diagram of a walking route determination apparatus according to the present embodiment.

FIG. 4 is a diagram for explaining map-matching of a first candidate and a second candidate to a link.

FIG. 5 is a diagram illustrating an example of a result of determining a traveling direction according to a comparative example.

FIG. 6 is a diagram illustrating an example of a result of determining a traveling direction according to the present embodiment.

FIG. 7 is a diagram for explaining conversion of a C/No value into a signal evaluation value.

FIG. 8 is a diagram for explaining a left half side and a right half side with respect to a traveling direction of a pedestrian.

FIG. 9 is a diagram for explaining an NLOS value.

FIG. 10 is a diagram illustrating an example of a result of calculating a signal evaluation value.

FIG. 11 is a diagram illustrating an example of a result of calculating an NLOS value.

FIG. 12 is a diagram illustrating an example of a result of calculating an environmental value.

FIG. 13 is a diagram illustrating an example of correctness values of left and right environmental values and satellite positioning values.

FIG. 14 is a diagram for explaining determination of a walking route.

FIG. 15 is a flowchart illustrating an example of a flow of processing performed using a walking route determination program according to the present embodiment.

FIG. 16 is a diagram for explaining candidate calculation, section determination, and traveling direction determination.

FIG. 17 is a diagram for explaining calculation of an environmental value.

FIG. 18 is a diagram for explaining calculation of a signal evaluation value.

FIG. 19 is a diagram for explaining calculation of an NLOS value.

FIG. 20 is a diagram for explaining determination of a walking route.

FIG. 21 is a diagram illustrating an example of a determination result of a walking route in a case in which only map-matching is applied.

FIG. 22 is a diagram illustrating an example of a determination result of a walking route in a case in which the present embodiment is applied.

FIG. 23 is a diagram for explaining map-matching to a route network representing roadways.

FIG. 24 is a diagram for explaining a problem of the map-matching to the route network representing roadways.

### DESCRIPTION OF EMBODIMENTS

Hereinafter, an example of an embodiment for implementing the disclosed technique will be described in detail with reference to drawings.

In view of the fact that deterioration in a reception environment of satellite signals leads to deterioration in positioning accuracy is not taken into consideration in the related art, whether the reception environment is good or bad is taken into consideration in the present embodiment.

For example, because an intensity of a received satellite signal is attenuated by about 10 dB if the signal is reflected by a building or the like, the intensity reflects the bad environment. Also, a fact that a satellite signal that is supposed to be able to be received cannot be received from a satellite orbit indicates that the satellite is blocked due to the bad environment.

Thus, an attenuated signal intensity is taken into consideration, and whether an environment is good or bad is quantified using the intensities of all the received signals in the present embodiment. Also, a satellite signal that cannot be received is also quantified as the bad environment.

Here, a principle of the present embodiment will be described.

In the present embodiment, positions of a pedestrian (left or right) are determined using the fact that the amount of arrival of satellite signals changes due to the influence of buildings in an urban canyon surrounded by buildings, for example.

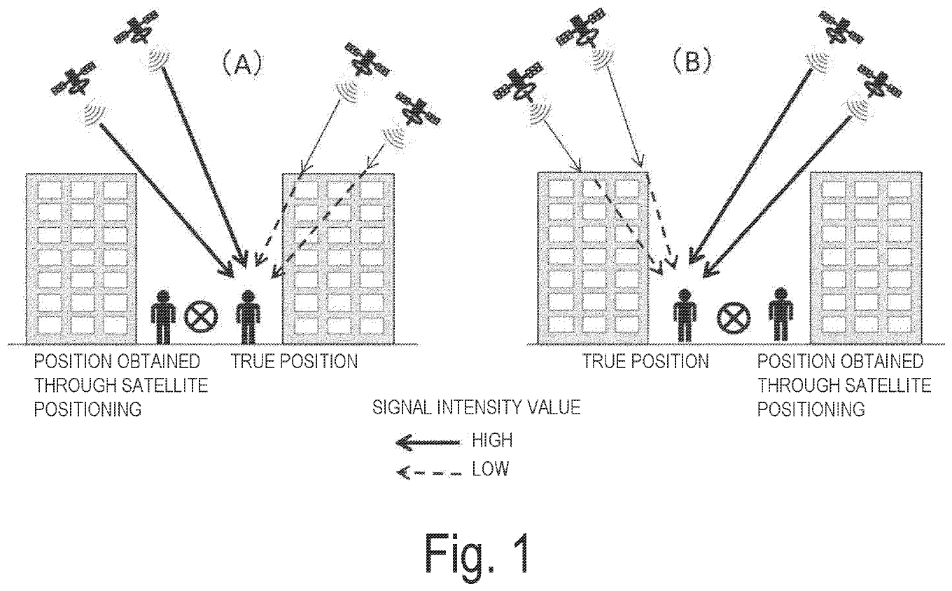

Specifically, in a case in which a pedestrian is walking along the right one of sidewalks with roadways interposed therebetween as illustrated in FIG. 1(A), an average of reception intensities of satellite signals from satellites positioned on the left side of the pedestrian is greater than an average of signal intensities of satellite signals from satellites positioned on the right side of the pedestrian. On the other hand, in a case in which the pedestrian is walking along the left one of the sidewalks with roadways interposed therebetween as illustrated in FIG. 1(B), an average of signal intensities of satellite signals from the satellites positioned on the right side of the pedestrian is greater than an average of reception intensity of satellite signals from the satellites positioned on the left side of the pedestrian. Thus, if the average of the signal intensities of the satellite signals from the satellites positioned on the left (right) side with reference to a traveling direction of the pedestrian is greater, it is possible to determine that the pedestrian is walking along the right (left) one of the sidewalks with roadways interposed therebetween.

Also, in the present embodiment, bad line of sight of the satellites as seen from the pedestrian is judged using information regarding whether the satellite signals could be received, and positions (left or right) of the pedestrian are determined based on the judgment results.

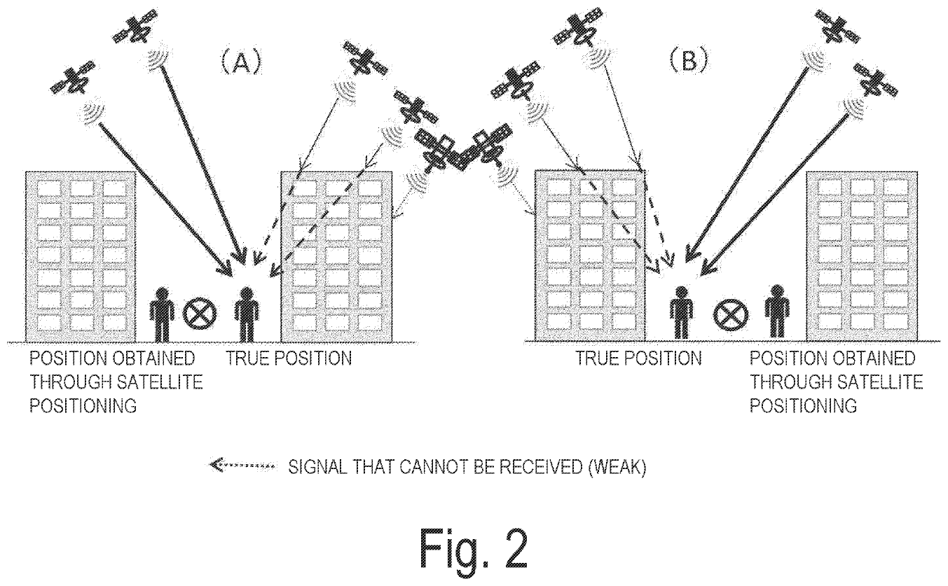

Specifically, in a case in which the pedestrian is walking along right one of sidewalks with roadways interposed therebetween as illustrated in FIG. 2(A), satellites from which satellite signals cannot be received are present on the right side of the pedestrian. On the other hand, in a case in which the pedestrian is walking along left one of sidewalks with roadways interposed therebetween as illustrated in FIG. 2(B), satellites from which satellite signals cannot be received are present on the left side of the pedestrian. Thus, if it is not possible to receive the satellite signals from the satellites positioned on the left (right) side with reference to the traveling direction of the pedestrian, it is possible to determine that the pedestrian is walking along the left (right) one of the sidewalks with roadways interposed therebetween.

Note that in FIGS. 1 and 2, the traveling direction of the pedestrian is a direction from the closer side toward the further side in the paper surface.

A walking route determination apparatus according to the present embodiment is configured as a computer including a central processing unit (CPU), a random access memory (RAM), a read only memory (ROM), a hard disk drive (HDD), and the like. A walking route determination program according to the present embodiment is stored in the ROM. Note that the walking route determination program may be stored in the HDD.

Also, the walking route determination program may be installed in advance in the walking route determination apparatus, for example. The walking route determination program may be implemented by being installed in the walking route determination apparatus appropriately by being stored in a nonvolatile storage medium or being distributed via a network. Note that examples of the nonvolatile storage medium include a compact disc read only memory (CD-ROM), a magneto-optical disc, a digital versatile disc read only memory (DVD-ROM), a flash memory, a memory card, and the like.

The CPU functions as each of functional units of the walking route determination apparatus, which will be described below, by reading and executing the walking route determination program stored in the ROM.

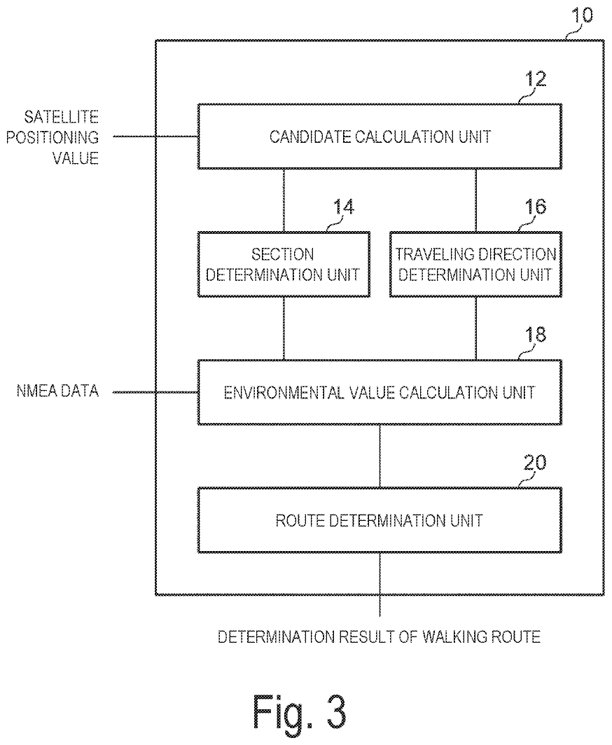

As illustrated in FIG. 3, satellite positioning values indicating the position of the pedestrian measured at every reception time based on satellite signals received from each of a plurality of satellites by a satellite positioning apparatus using a global navigation satellite system (GNSS) that the pedestrian as a positioning target holds are input to the walking route determination apparatus 10 according to the present embodiment. Also, NMEA data included in the satellite signals received from each of the satellites is input to the walking route determination apparatus 10. Information such as carrier/noise ratio (C/No) indicating reception intensities of satellite signals, satellite numbers, angles of elevation of the satellites, azimuth angles of the satellites, and position dilution of precision (PDOP) is included in the NMEA data input to the walking route determination apparatus 10.

The walking route determination apparatus 10 includes, in terms of functions, a candidate calculation unit 12, a section determination unit 14, a traveling direction determination unit 16, an environmental value calculation unit 18, and a route determination unit 20.

The candidate calculation unit 12 calculates a first candidate and a second candidate of walking routes positioned to face each other in regard to roadways along the traveling direction of the pedestrian through map-matching of the input satellite positioning values at every reception time to any of links configuring a walking route network.

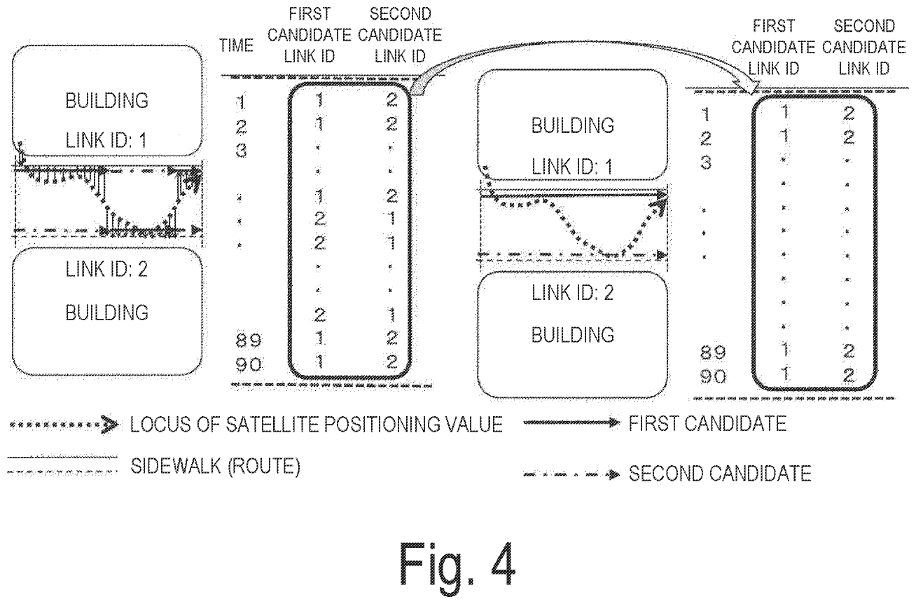

Specifically, the walking route network including sidewalks with roadways interposed therebetween is used as illustrated in FIG. 24 in the present embodiment. The candidate calculation unit 12 calculates distances between a satellite positioning value and all the links on the walking route network and matches the satellite positioning value to the link with the shortest distance. At this time, the candidate calculation unit 12 regards the link to which the satellite positioning value is matched as a first candidate and regards a link indicating a sidewalk on the side opposite to the sidewalk corresponding to the link of the first candidate with roadways interposed therebetween as a second candidate, as illustrated in FIG. 4. The candidate calculation unit 12 allocates identification information (hereinafter, referred to as “link IDs”) of the links that are the first candidate and the second candidate to the satellite positioning value at each reception time.

Also, the candidate calculation unit 12 smooths link IDs of the first candidate at all times in a section with the link ID that most frequently appears in the link IDs allocated as the first candidate for each section determined by the section determination unit 14, which will be described below, as illustrated in FIG. 4. Link IDs of the second candidate are also similarly smoothed.

The section determination unit 14 determines a section using, as a boundary, a timing at which the link IDs of the first candidate and the second candidate calculated by the candidate calculation unit 12 change simultaneously. For example, the section determination unit 14 determines, as a section separation point, a boundary between a time t and a time t+1 in a case in which link IDs allocated to satellite positioning values at each time until a reception time t are 1 or 2 and link IDs allocated to satellite positioning values at each time from the time t+1 are 3 or 4.

The traveling direction determination unit 16 determines a traveling direction of the pedestrian based on a code of a calculated value based on an inner product between a unit vector indicating a direction of the satellite positioning apparatus obtained from satellite positioning values at consecutive reception times and a unit vector indicating a direction of the link of the first candidates or the second candidates. As the calculated value based on the inner product, an inner product value between a unit vector indicating the direction of the satellite positioning apparatus at each positioning location and a unit vector indicating the direction of the link or an average value of inner product values of unit vectors indicating two directions in the section determined by the section determination unit 14 is used. In a case in which an average value of the inner product values in the section is used, the traveling direction determination unit 16 regards the direction of the link in which the average value of the inner products in the section is positive as the direction of the link of the first candidate or the second candidate allocated in the section. Also, the traveling direction determination unit 16 determines that the pedestrian is traveling in the direction of the link with consecutively matched satellite positioning values and decides the direction of the link as the traveling direction of the pedestrian.

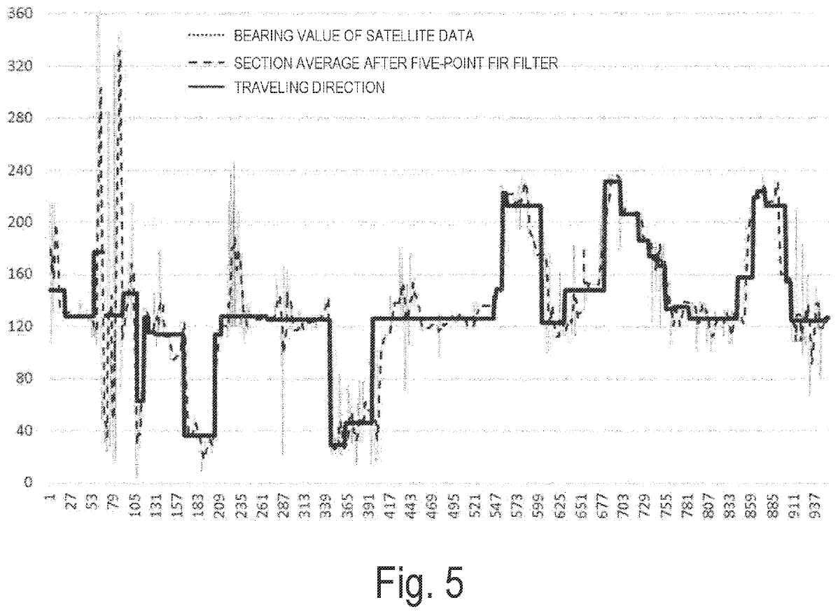

Here, in FIG. 5, a section average is calculated (the dashed line in FIG. 5) after performing five-point FIR filtering on a bearing value (the dotted line in FIG. 5) of satellite data, and the traveling direction (the solid line in FIG. 5) is illustrated as a comparative example. In this case, the traveling direction is unclear.

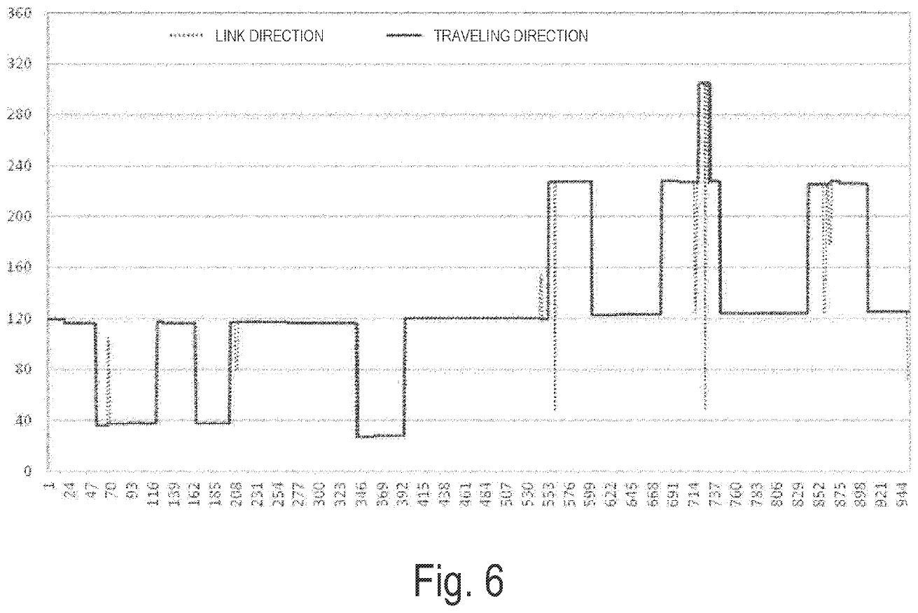

On the other hand, FIG. 6 illustrates the traveling direction (the solid line in FIG. 6) determined using the direction of the link (the dotted line in FIG. 6) by the traveling direction determination unit 16 according to the present embodiment. In this case, the determined traveling direction was confirmed to substantially conform to an actual traveling direction.

The environmental value calculation unit 18 calculates an environmental value indicating whether a reception environment of satellite data is good or bad for each of a right half side and a left half side with reference to the traveling direction of the pedestrian based on the input NMEA data.

Specifically, the environmental value calculation unit 18 calculates the environmental value using a value indicating the amount of arrival of satellite signals (C/No values: carrier noise density ratio) and a value indicating whether the lines of sight of satellites when seen from the pedestrian are good or bad.

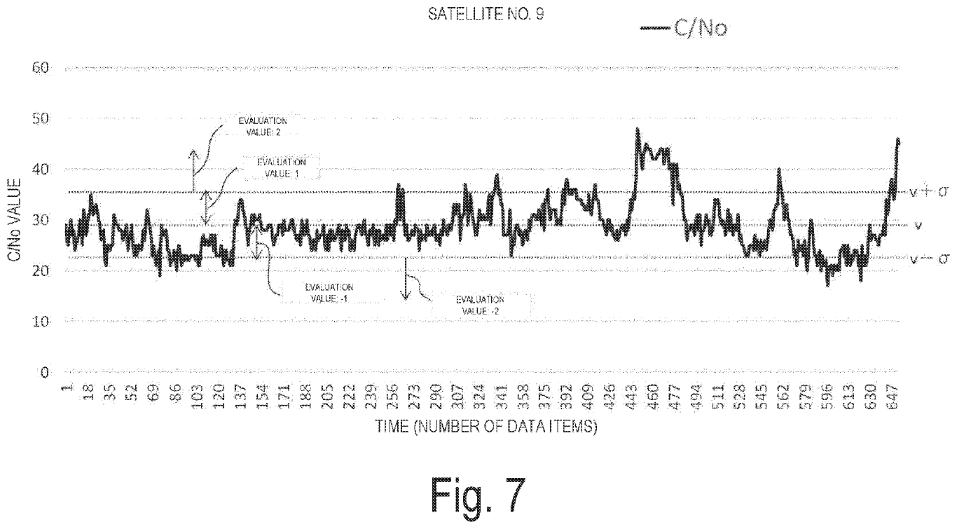

More specifically, the environmental value calculation unit 18 may directly use the satellite signal values (C/No values) as signal evaluation values or, as illustrated in FIG. 7, may obtain an average (v) and dispersion (σ) of C/No values for each section in units of satellites and convert the satellite signal values (C/No values) into four-value signal evaluation values as follows using v+σ, v, v−σ as threshold values.
C/No≥(v+σ)→signal evaluation value: 2
(v+σ)>C/No≥v→signal evaluation value: 1
V>C/No≥(v−σ)→signal evaluation value: −1
(v−σ)>C/No→signal evaluation value: −2

Then, the environmental value calculation unit 18 determines whether a position (azimuth angle) of each satellite is in the left half side or the right half side in regard to satellites with angles of elevation of equal to or greater than a predetermined threshold value with reference to the traveling direction of the pedestrian and obtains a sum of signal evaluation values of each of the left half side and the right half side.

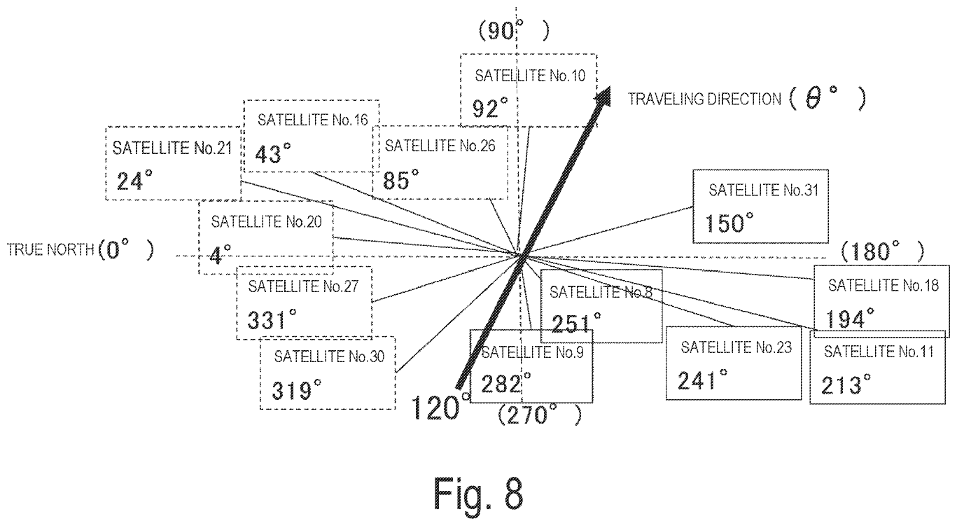

Here, determination of the left half side and the right half side will be described with reference to FIG. 8. If the reference (0°) of the azimuth angle is defined as true north, the traveling direction of the pedestrian is defined as θ, and the azimuth angle of a satellite is α, it is possible to determine that the satellite is positioned in the left half side with respect to the traveling direction in a case in which 180°≤α−θ<360°. Also, in a case in which 0°≤α−θ<180°, it is possible to determine that the satellite is positioned in the right half side with respect to the traveling direction. However, in a case in which α−θ<0°, 360° is added to a for determination.

The environmental value calculation unit 18 calculates a sum of signal evaluation values calculated from NMEA data from satellites positioned in the left half side and a sum of signal evaluation values calculated from NMEA data from satellites positioned in the right half side in regard to the satellites with angles of elevation of equal to or greater than a specified value.

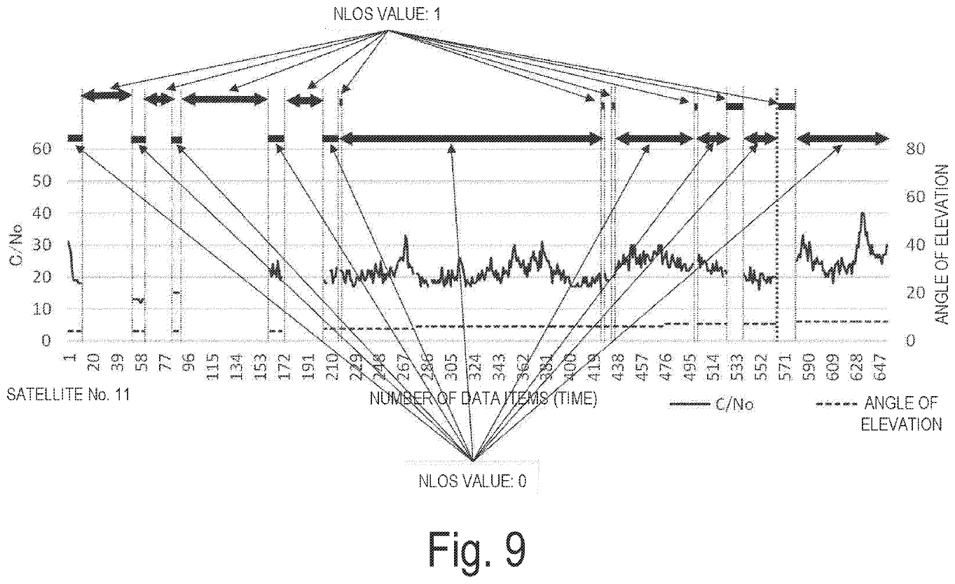

Also, the environmental value calculation unit 18 considers that “the pedestrian cannot see satellites” in regard to satellites with angles of elevation of less than the predetermined threshold value at a time with no C/No value is present (empty data) in the NMEA data and sets a non line of site (NLOS: no visibility) value as “1” for one satellite, as illustrated in FIG. 9. The environmental value calculation unit 18 calculates a sum of NLOS values of the satellites positioned in the left half side and a sum of NLOS values of the satellites positioned in the right half side with reference to the traveling direction of the pedestrian.

Then, the environmental value calculation unit 18 calculates the environmental value of each of the left half side and the right half side using Equation (1) below.

$$[ Math . 1 ]$$

$$Environmental value of left ( right ) half side = \frac{\begin{matrix}\begin{matrix}( Sum of signal evaluation \\ values for left ( right ) half side ) -\end{matrix} \\ ( Sum of NLOS values for left ( right ) half side )\end{matrix}}{\begin{matrix}( Number of satellites positioned \\ in the left ( right ) half side )\end{matrix}} \qquad ( 1 )$$

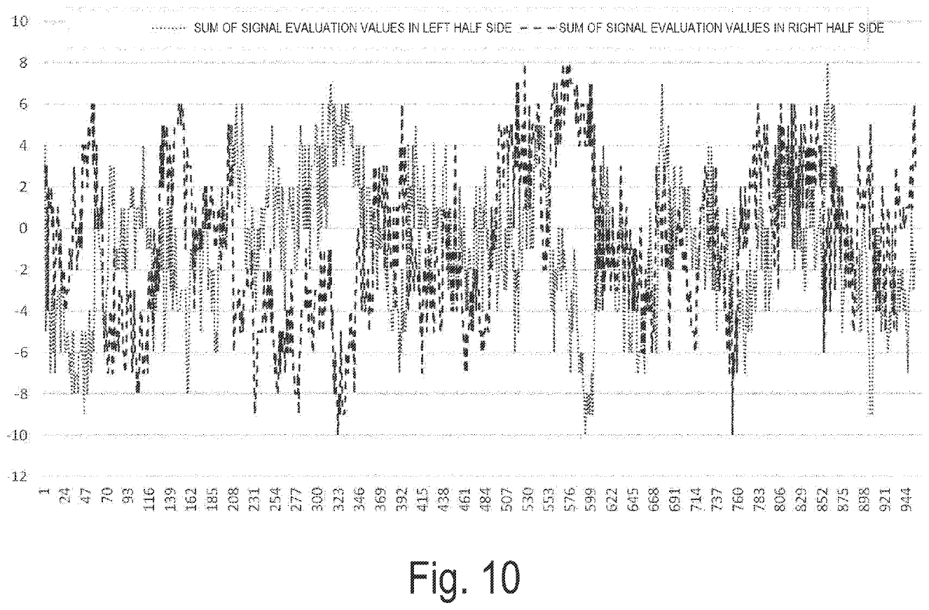

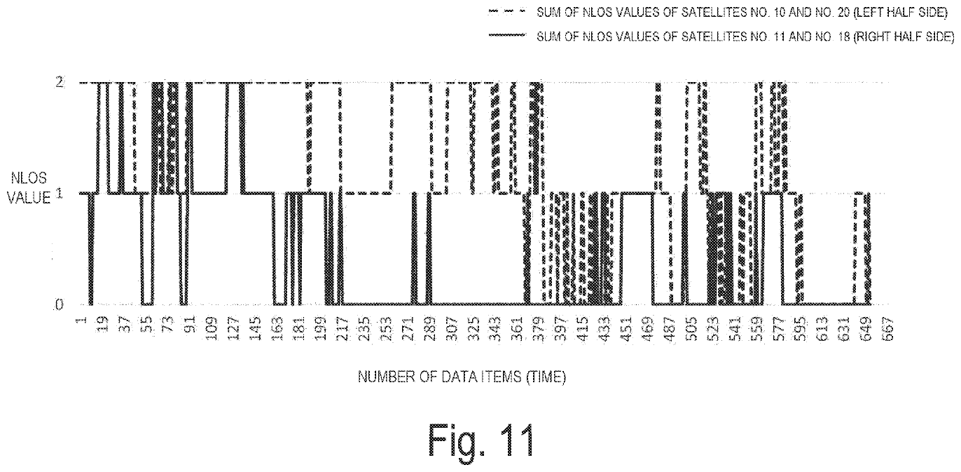

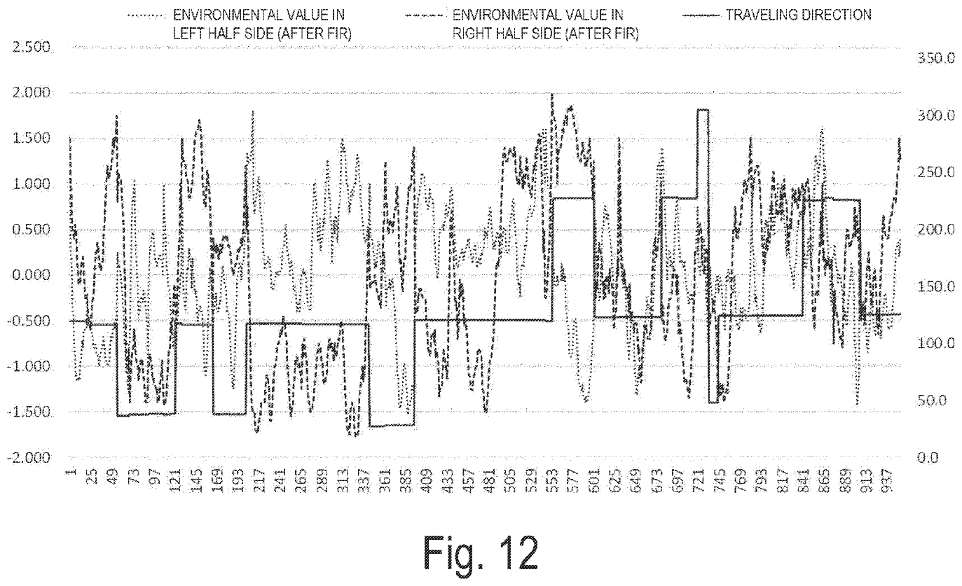

FIG. 10 illustrates an example of a result of calculating signal evaluation values, FIG. 11 illustrates an example of a result of calculating NLOS values, and FIG. 12 illustrates an example of a result of calculating environmental values. In FIGS. 10 to 12, the dotted lines represent values in the left half side, the dashed lines represent values in the right half side, and in FIG. 12, the solid line represents the traveling direction.

The route determination unit 20 determines a walking route of the pedestrian through comparison between the environmental value in the left half side and the environmental value in the right half side calculated by the environmental value calculation unit 18. Specifically, the route determination unit 20 compares the left and right environmental values for each section and selects, as an estimated route, the first candidate or the second candidate corresponding to the direction (the left or the right) in which the environmental value is smaller.

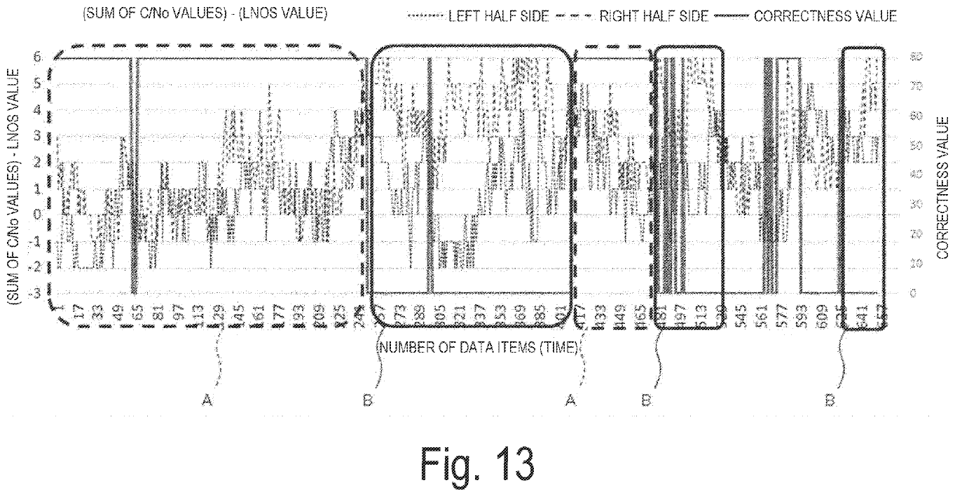

FIG. 13 illustrates an example of correctness values of the left and right environmental values and satellite positioning values. In the portion represented by the dashed line A, both the left and right environmental values are small values and are similar to those in the incorrect value range. In the portion represented by the solid line B, the right environmental value becomes a maximum value and is similar to the correct value range. Also, the right environmental value is a large value, the left environmental value is a small value, and the difference therebetween is also large. This indicates that the environment in the left half side is bad while the environment in the right half side is good. In other words, this indicates that there are many obstacles such as buildings on the left side of the pedestrian while there are roadways and are no obstacles on the right side. Thus, it is possible to determine that the pedestrian is walking along the sidewalk on the left side in the traveling direction with a high probability.

Also, the route determination unit 20 obtains an average value (section average: vₚ) of PDOP values for each section and determines a threshold value β (=v_{p_all}+σ_{p_all}) from an average value (v_{p_all}) and standard deviation (σ_{p_all}) of all section averages. In addition, the route determination unit 20 selects, as a final estimated route, the first candidate or the second candidate on the opposite side of the first candidate or the second candidate selected as the estimated route based on the aforementioned environmental values in a case in which the PDOP section average vₚ is greater than the threshold value P.

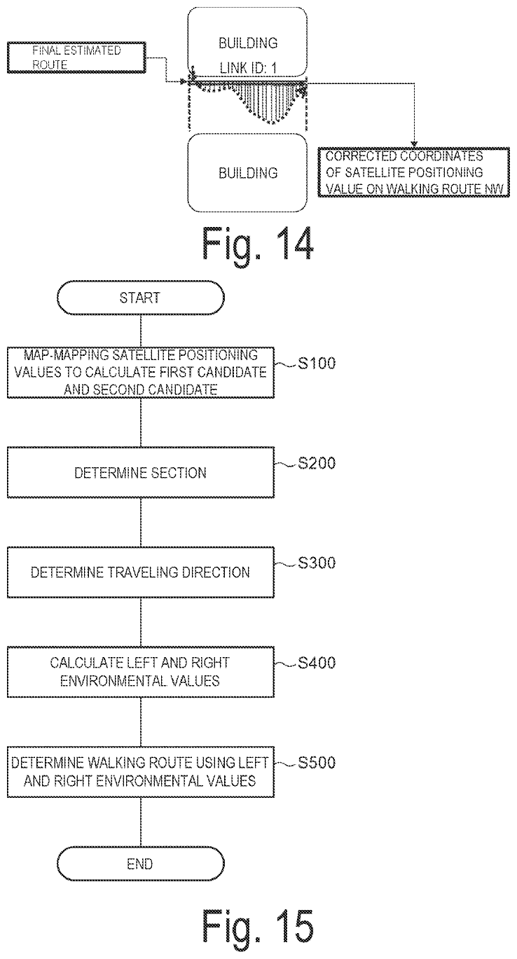

Also, the route determination unit 20 corrects the satellite positioning values to positions on the walking route network and determines the walking route through map-matching the satellite positioning values at each reception time with respect to the final estimated route as illustrated in FIG. 14.

Next, behavior of the walking route determination apparatus 10 according to the present embodiment will be described with reference to FIG. 15. Note that FIG. 15 is a flowchart illustrating an example of a flow of processing performed by the walking route determination program according to the present embodiment.

In Step S100 in FIG. 15, the candidate calculation unit 12 calculates the first candidate and the second candidate of a walking route with roadways interposed therebetween through map-matching the input satellite positioning values at each reception time to any of links configuring the walking route network.

Next, in Step S200, the section determination unit 14 determines sections of the satellite positioning values that are time-series data.

Next, in Step S300, the traveling direction determination unit 16 determines the traveling direction of the pedestrian for each of the sections.

The processing in Steps S100 to S300 will be described in more detail with reference to FIG. 16.

When the satellite positioning values are input in Step S102, the candidate calculation unit 12 calculates distances between the satellite positioning values and all links on the walking route network and matches the satellite positioning values to the link with the shortest distance in Step S104. At this time, the candidate calculation unit 12 regards the link to which the satellite positioning values are matched as the first link and regards the link representing the sidewalk on the side with roadways interposed with the sidewalk corresponding to the link of the first candidate as the second candidate. Then, the candidate calculation unit 12 allocates link IDs of links that are the first candidate and the second candidate to the satellite positioning values at each reception time.

Next, in Step S106, the section determination unit 14 determines a section using, as a boundary, a timing at which the link IDs of the first candidate and the second candidate calculated by the candidate calculation unit 12 change simultaneously.

Also, in Step S108, the traveling direction determination unit 16 obtains two directions, namely a forward direction and a backward direction, for each of the links from coordinates of a start point and an end point of each of the links configuring the walking route network. Also, in Step S110, the traveling direction determination unit 16 obtains the direction of the satellite positioning apparatus from the satellite positioning values at consecutive reception times.

Then, in Step S112, the traveling direction determination unit 16 calculates an inner product between the direction of the satellite positioning apparatus obtained in Step S110 and the direction of the link obtained in Step S108 for each point at each reception time and obtains an average value of the inner products for each section determined in Step S106.

Also, in Step S114, the candidate calculation unit 12 smooths link IDs of the first candidate and the second candidate at all times in the section with the link ID that most frequently appears in the link IDs allocated as the first candidate and the second candidate in Step S104 for each section.

Also, in Step S116, the traveling direction determination unit 16 outputs the direction of the link in which the average value of the inner products in the section obtained in Step S112 is positive as the direction of the link of the first candidate or the second candidate allocated in that section.

Next, in Step S118, the traveling direction determination unit 16 extracts the direction of the link corresponding to the link ID smoothed in Step S114 from the direction of the link output in Step S116.

Next, in Step S120, the traveling direction determination unit 16 determines the direction of the link extracted in Step S118 as the traveling direction of the pedestrian in that section.

Returning to FIG. 15, the environmental value calculation unit 18 calculates environmental values of the left half side and the right half side with reference to the traveling direction of the pedestrian in next Step S400.

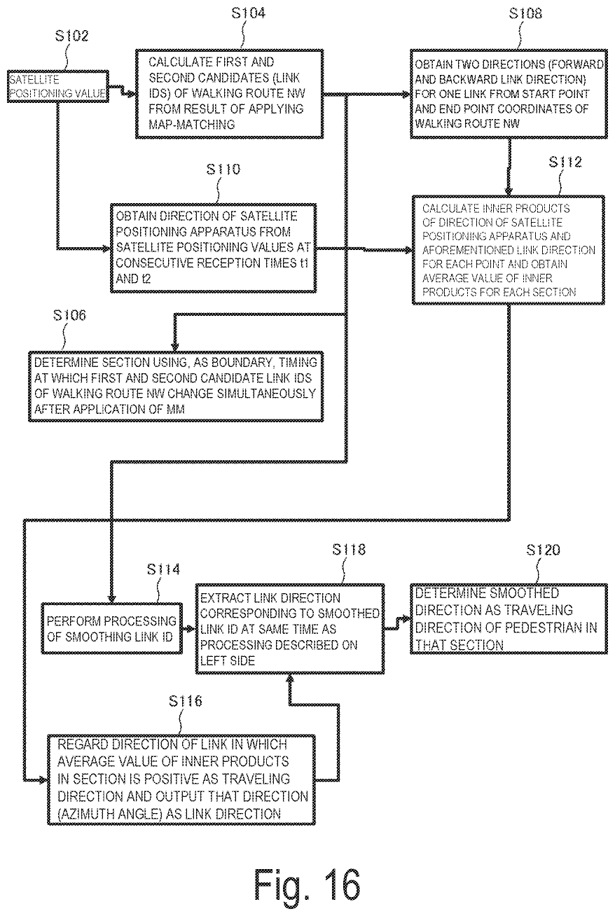

The processing in Step S400 will be described in more detail with reference to FIG. 17.

In step S402, the environmental value calculation unit 18 acquires NMEA data obtained from data received from each satellite. Also, in Step S404, the environmental value calculation unit 18 acquires information regarding the section determined by the section determination unit 14. Also, in Step S406, the environmental value calculation unit 18 acquires the traveling direction of the pedestrian determined by the traveling direction determination unit 16.

Next, in Step S408, the environmental value calculation unit 18 directly handles the C/No value included in the NMEA data as a signal evaluation value, or converts the C/No value into a four-value (2, 1, −1, −2) signal evaluation values for each section in units of satellites.

Next, in Step S410, the environmental value calculation unit 18 determines whether the position (azimuth angle) of each satellite is in the left half side or the right half side with reference to the traveling direction of the pedestrian for each section and obtains a sum of signal evaluation values for each of the left half side and the right half side.

Also, in Step S412, the environmental value calculation unit 18 obtains a sum of NLOS values for each of the left half side and the right half side for each section in units of satellites based on the NMEA data.

Then, in Step S414, the environmental value calculation unit 18 calculates an environmental value for each of the left half side and the right half side by Equation (1), for example, using the sum of the left and right signal evaluation values calculated in Step S410 and the sum of the left and right NLOS values calculated in Step S412.

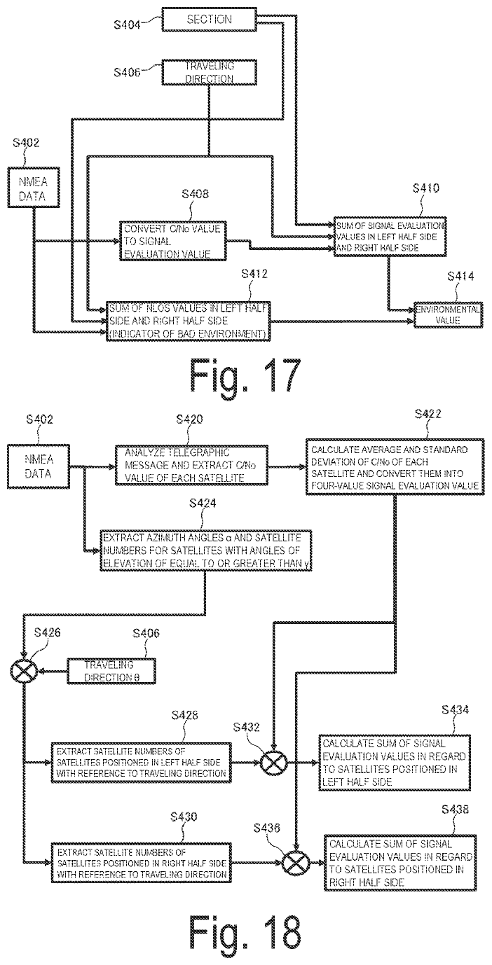

Here, Step S410 in FIG. 17 and steps related thereto will be described in more detail with reference to FIG. 18.

In Step S420, the environmental value calculation unit 18 analyzes a telegraphic message indicated by the NMEA data of each satellite acquired in Step S402 and extracts the C/No value of each satellite.

Next, in Step S422, the environmental value calculation unit 18 directly handles the C/No value included in the NMEA data as the signal evaluation value or obtains an average (v) and dispersion (σ) thereof and converts them into a four-value (2, 1, −1, −2) signal evaluation value using v+σ, v, and v−σ as threshold values, for each section in units of satellites. The environmental value calculation unit 18 stores the converted signal evaluation value once in association with a satellite number of the corresponding satellite.

Also, in Step S424, the environmental value calculation unit 18 extracts azimuth angles α and satellite numbers in regard to satellites with angles of elevation of equal to or greater than the threshold value γ with reference to the NMEA data.

Next, in Step S426, the environmental value calculation unit 18 determines which of conditions in the following two cases are satisfied using the traveling direction θ of the pedestrian acquired in Step S406 and the azimuth angles α of the satellites extracted in Step S424 with reference (0°) to the true north. The two cases are a case in which the relation between θ and α satisfies 0°≤α−θ<180° and a case in which the relation between θ and α satisfies 180°≤α−θ<360° (however, in a case in which α−θ<0°, 360° is added to a to make determination).

For the satellites corresponding to the former case, the environmental value calculation unit 18 regards the satellites as satellites positioned in the left half side with respect to the traveling direction of the pedestrian and extracts satellite numbers thereof in Step S428. For the satellites corresponding to the latter case, the environmental value calculation unit 18 regards the satellites as satellites positioned in the right half side with respect to the traveling direction of the pedestrian and extracts satellite numbers thereof in Step S430.

Next, in Step S432, the environmental value calculation unit 18 extracts signal evaluation values stored in association with the satellite numbers of the satellites positioned in the left half side, which have been extracted in Step S428, from among the signal evaluation values of the satellites converted in Step S422. Then, in Step S434, the environmental value calculation unit 18 calculates a sum of the signal evaluation values of the satellites positioned in the left half side, which have been extracted in Step S432.

Similarly, in Step S436, the environmental value calculation unit 18 extracts signal evaluation values stored in association with the satellite numbers of the satellites positioned in the right half side, which have been extracted in Step S430, from among the signal evaluation values of the satellites converted in Step S422. Then, in step S438, the environmental value calculation unit 18 calculates a sum of the signal evaluation values of the satellites positioned in the right half side, which have been extracted in Step S436.

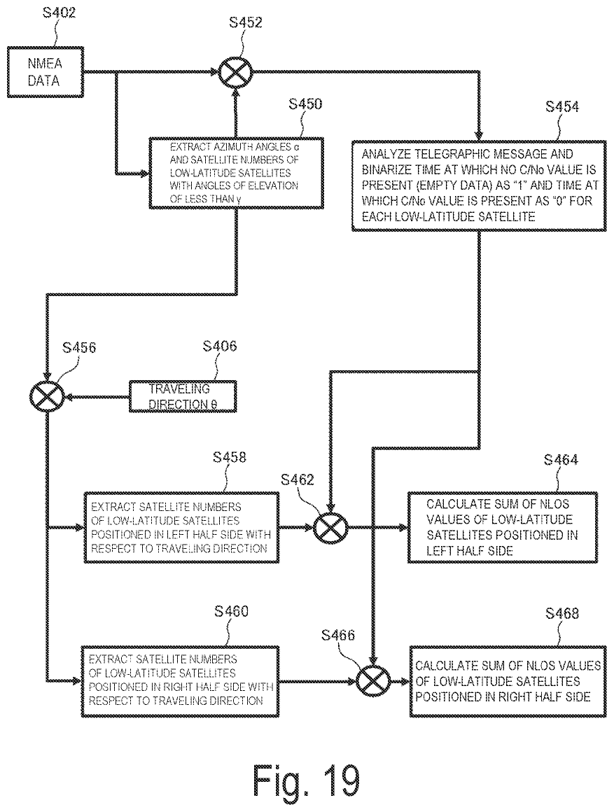

Next, Step S412 in FIG. 17 and steps related thereto will be described in more detail with reference to FIG. 19.

In Step S450, the environmental value calculation unit 18 extracts azimuth angles α and satellites numbers of low-latitude satellites with angles of elevation of less than γ degrees with reference to the NMEA data acquired in Step S402. Next, in step S452, the environmental value calculation unit 18 extracts NMEA data corresponding to the satellite numbers extracted in Step S450. Next, in Step S454, the environmental value calculation unit 18 analyzes a telegraphic message indicated by the NMEA data in regard to the low-latitude satellites extracted in Step S452 and binarizes a time at which there is no C/No value (empty data) as “1” and a time at which there is a C/No value as “0” for each of the low-latitude satellites. The environmental value calculation unit 18 stores once a sum of the binarized values at each time in the section as an NLOS value of each low-latitude satellite in association with the satellite number of the low-latitude satellite for each low-latitude satellite.

Next, in Steps S456 to S460, the satellite numbers of the satellites positioned in the left half side and the satellite numbers of the satellites positioned in the right half side with respect to the traveling direction of the pedestrian are extracted similarly to Steps S426 to S430 in FIG. 18. Note that the determination results in Steps S426 to S430 in FIG. 18 may be used instead of those in Steps S456 to S460.

Next, in Step S462, the environmental value calculation unit 18 extracts NLOS values stored in association with the satellite numbers of the satellites positioned in the left half side, which have been extracted in Step S458, from among the NLOS values of the low-latitude satellites calculated in Step S454. Then, in step S464, the environmental value calculation unit 18 calculates a sum of the NLOS values of the low-latitude satellites positioned in the left half side, which have been extracted in Step S462.

Similarly, in step S466, the environmental value calculation unit 18 extracts NLOS values stored in association with the satellite numbers of the satellites positioned in the right half side, which have been extracted in Step S460, from among the NLOS values of the low-latitude satellites calculated in Step S454. Then, in step S468, the environmental value calculation unit 18 calculates a sum of the NLOS values of the low-latitude satellites positioned in the right half side, which have been extracted in Step S466.

Returning to FIG. 15, in next Step S500, the route determination unit 20 determines the walking route using the environmental value of each of the left half side and the right half side calculated in Step S400.

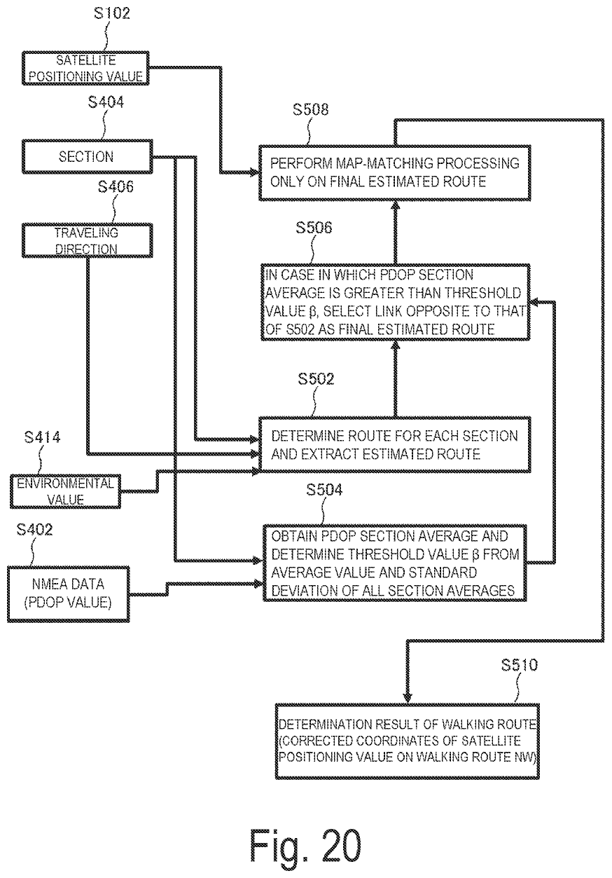

The processing in Step S500 will be described in more detail with reference to FIG. 20.

In Step S502, the route determination unit 20 compares the environmental value of the left half side and the environmental value of the right half side calculated in Step S414 for each section acquired in Step S404 and selects the first candidate or the second candidate corresponding to the direction (left or right) with a smaller environmental value as an estimated route. For example, in a case in which the first candidate is a link representing the left sidewalk with respect to the traveling direction of the pedestrian, the second candidate is a link representing the right sidewalk with respect to the traveling direction of the pedestrian, and the environmental value of the right half side is greater than the environmental value of the left half side, the first candidate is selected as an estimated route.

Also, in Step S504, the route determination unit 20 obtains an average value (section average: vₚ) of PDOP values included in the NMEA data acquired in Step S402 for each section and determines the threshold value β (=v_{p_all}+σ_{p_all}) from the average value (v_{p_all}) and the standard deviation (σ_{p_all}) of all section averages.

Next, in step S506, in a case in which the PDOP section average vₚ is greater than the threshold value β, the route determination unit 20 selects, as a final estimated route, the first candidate or the second candidate that is opposite to the first candidate or the second candidate selected as the estimated route in Step S502. In a case in which the PDOP section average vₚ is equal to or less than the threshold value D, the estimated route selected in Step S502 is directly regarded as the final estimated route.

Next, in step S508, the route determination unit 20 performs map-matching the satellite positioning values at each reception time input in Step S102 only to the final estimated route selected in Step S506.

Then, in step S510, the route determination unit 20 outputs, as a determination result of the walking route, the route indicated by the satellite positioning values corrected to the positions on the walking route network through the map-matching.

As described above, the walking route determination apparatus according to the present embodiment regards links indicating sidewalks on both sides with roadways interposed therebetween as candidates through map-matching. Then, the walking route determination apparatus according to the present embodiment calculates environmental values indicating whether the reception environments of satellite signals are good or bad for the left half side and the right half side with respect to the traveling direction of the pedestrian. Then, the walking route determination apparatus according to the present embodiment determines the walking routes from the candidates based on a difference between the left and right environmental values. Through these processing operations, the walking route determination apparatus according to the present embodiment can accurately determine the walking routes with roadways interposed therebetween.

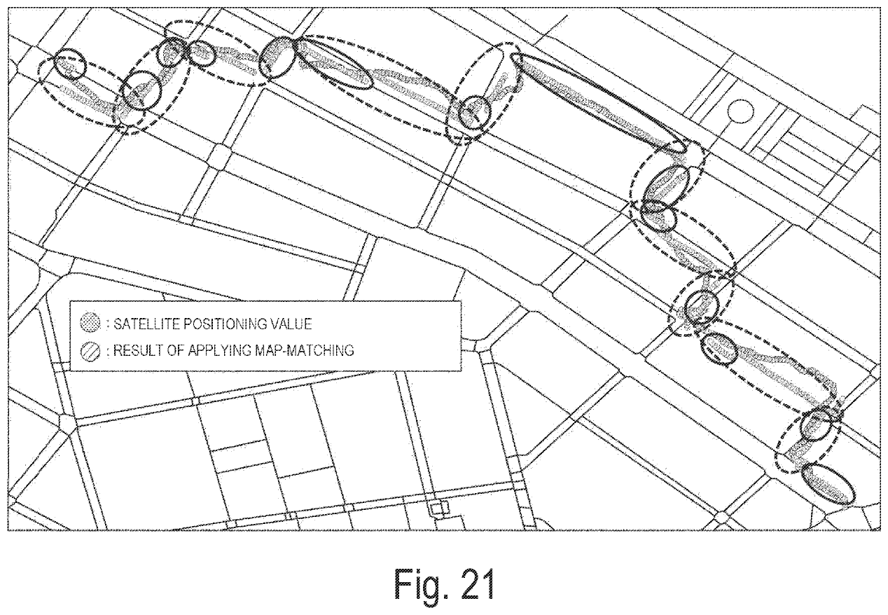

Here, FIG. 21 illustrates an example of a determination result of walking routes in a case in which only map-matching is applied. In this case, the correct answer rate of route determination was 53.9%. Note that in FIG. 21, the portion represented by the dashed-line oval is a portion in which it is difficult to determine routes only with map-matching, and the portion represented by the solid-line oval is a portion in which the routes are correctly determined only with map-matching.

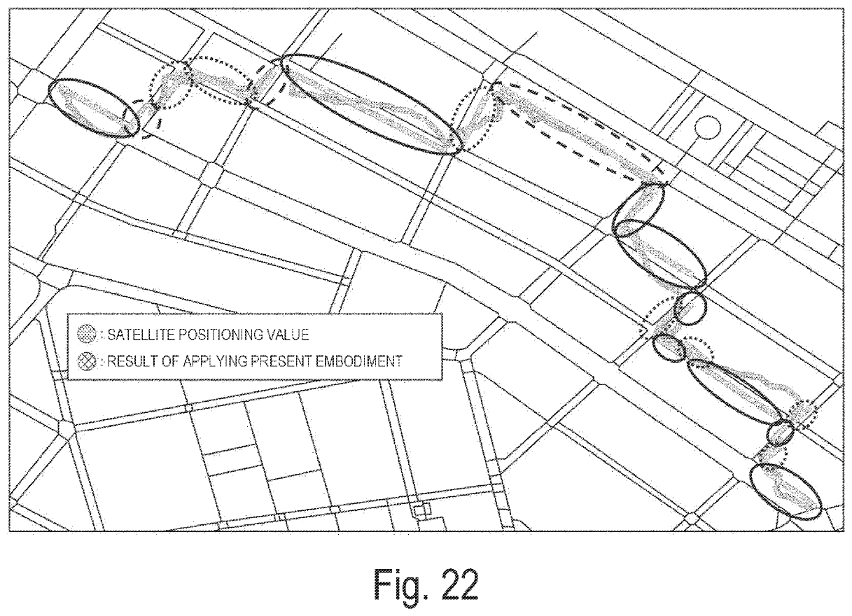

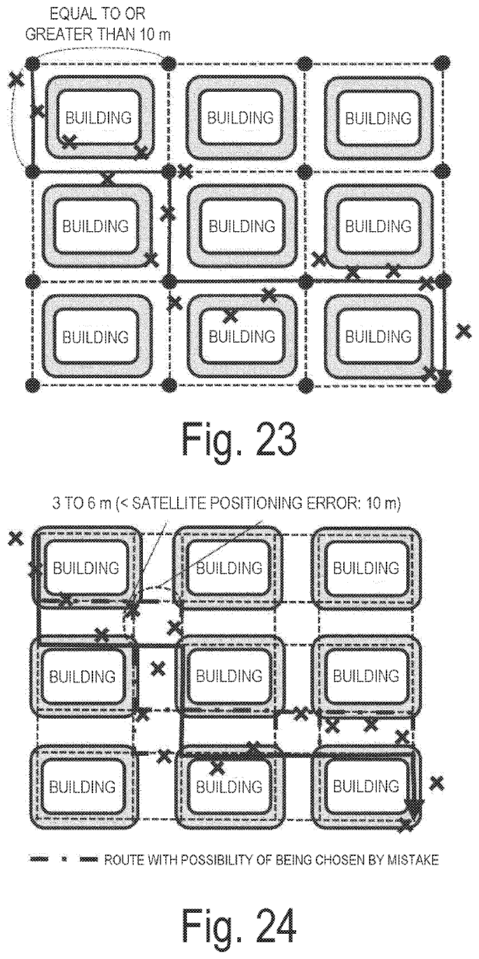

On the other hand, FIG. 22 illustrates an example of a determination result of walking routes in a case in which the present embodiment is applied. In this case, the correct answer rate of route determination was 71.1%. Note that in FIG. 22, the portion represented by the solid-line oval is a portion where satellite positioning values have been accurately corrected, the portion represented by the dashed-line oval is a portion in which the routes are correctly determined even by a method using only map-matching in the related art, and the portion represented by the dotted-line oval is a portion in which the routes are erroneously determined in the present embodiment.

As described above, it is possible to ascertain that the correct answer rate is improved in the present embodiment as compared with the case in which only map-matching is applied and that walking routes with roadways interposed therebetween can be precisely determined.

Note that each configuration and processing of the walking route determination apparatus described in the aforementioned embodiment are just an example and can be modified in accordance with situations without departing from the gist.

For example, the values calculated as environmental values are not limited to those in the example of the aforementioned embodiment, and may be values using only indicators in relation to C/No values, values using only indicators in relation to NLOS values, or values obtained by dividing C/No values by NLOS values, for example. Also, it is only necessary to use any values that are indicators of whether the reception environments of satellite signals are good or bad, and the environmental values may be calculated using indicators other than the C/No values and the NLOS values.

Also, the methods of determining the section and the traveling direction are not limited to those in the example of the aforementioned embodiment.

However, accuracy of the traveling direction is stabilized by determining the traveling direction of the pedestrian based on the satellite positioning values, the walking route network, and continuity of results of map-matching as in the present embodiment. Also, it is possible to accurately determine a section by determining the section based on the results of map-matching as in the present embodiment.

In this manner, robustness of the processing is further improved by implementing the aforementioned techniques in a comprehensively combined manner, and the processing can be applied when there is discontinuity or complexity in the geographical space of urban areas, when errors of satellite positioning values increase due to influences (discontinuity of geographical space) of buildings, and complicated walking routes and the like.

In addition, the flow of the processing of the program described in the aforementioned embodiment is also an example, and unnecessary steps may be deleted, new steps may be added, or the processing order may be changed without departing from the gist.

Also, although the case in which the processing according to the above embodiment is implemented by a software configuration using a computer executing the program has been described in the aforementioned embodiment, the embodiment is not limited thereto. The embodiment may be implemented by a hardware configuration or a combination of a hardware configuration and a software configuration, for example.

### REFERENCE SIGNS LIST

10 Walking route determination apparatus
12 Candidate calculation unit
14 Section determination unit
16 Traveling direction determination unit
18 Environmental value calculation unit
20 Route determination unit

1. A walking route determination apparatus comprising:
an environmental value determiner configured to determine, based on a plurality of satellite signals from a plurality of satellites received by a positioning apparatus held by a pedestrian of object, an environmental value indicating whether a reception environment of a satellite signal of the plurality of satellite signals is good or bad for a left half side and a right half side with reference to a traveling direction of the pedestrian; and
a route determiner configured to compare an environmental value of the left half side determined by the environmental value determiner with an environmental value of the right half side determined by the environmental value determiner to determine a walking route of the pedestrian.

2. The walking route determination apparatus according to claim 1, wherein the environmental value determiner determines the environmental value using a value indicating an amount of arrival of the satellite signal.

3. The walking route determination apparatus according to claim 1, wherein the environmental value determiner determines the environmental value using a value indicating whether a line of sight of each of the plurality of satellites as seen from the pedestrian is good or bad.

4. The walking route determination apparatus according to claim 1, further comprising:
a candidate determiner configured to determine a first candidate and a second candidate of a walking route, the first candidate and the second candidate being positioned to face each other in relation to a roadway along the traveling direction of the pedestrian, through map-matching a position of the pedestrian measured at reception times based on the satellite signal received from each of the plurality of satellites to any of links configuring a walking route network, wherein the route determiner unit determines the walking route through map-matching the position of the pedestrian measured at each of the reception times to either the first candidate or the second candidate selected through comparison between the environmental value of the left half side and the environmental value of the right half side.

5. The walking route determination apparatus according to claim 4, further comprising:
a traveling direction determiner configured to determine the traveling direction of the pedestrian based on a sign of a determined value based on an inner product of a direction of the positioning apparatus obtained from positioning results of the pedestrian at consecutive reception times and a direction of a link determined as the first candidate or the second candidate.

6. The walking route determination apparatus according to claim 4, further comprising:
a section determiner configured to determine sections using, as a boundary, a timing at which links as the first candidate and the second candidate determined by the candidate determiner change simultaneously, wherein the environmental value determiner determines the environmental value of the left half side and the environmental value of the right half side for each of the sections determined by the section determiner, and the route determiner determines the walking route for each of the sections determined by the section determiner.

7. A walking route determination method comprising:
determining, by an environmental value determinerc based on a plurality of satellite signals from a plurality of satellites received by a positioning apparatus held by a pedestrian of object, an environmental value indicating whether a reception environment of a satellite signal of the plurality of satellite signals is good or bad for a left half side and a right half side with reference to a traveling direction of the pedestrian; and
comparing, by a route determiner, an environmental value of the left half side determined by the environmental value determiner with an environmental value of the right half side determined by the environmental value determiner to determine a walking route of the pedestrian.

8. A computer-readable non-transitory recording medium storing a computer-executable program instructions that when executed by a processor cause a computer system to:
determine, by an environmental value determiner based on a plurality of satellite signals from a plurality of satellites received by a positioning apparatus held by a pedestrian of object, an environmental value indicating whether a reception environment of a satellite signal of the plurality of satellite signals is good or bad for a left half side and a right half side with reference to a traveling direction of the pedestrian; and
compare, by a route determiner an environmental value of the left half side determined by the environmental value determiner with an environmental value of the right half side determined by the environmental value determiner to determine a walking route of the pedestrian.

9. The walking route determination apparatus according to claim 2, wherein the environmental value determiner determines the environmental value using a value indicating whether a line of sight of each of the plurality of satellites as seen from the pedestrian is good or bad.

10. The walking route determination method according to claim 7, wherein the environmental value determiner determines the environmental value using a value indicating an amount of arrival of the satellite signal.

11. The walking route determination method according to claim 7, wherein the environmental value determiner determines the environmental value using a value indicating whether a line of sight of each of the plurality of satellites as seen from the pedestrian is good or bad.

12. The walking route determination method according to claim 7, further comprising:
determining, by a candidate determiner, a first candidate and a second candidate of a walking route, the first candidate and the second candidate being positioned to face each other in relation to a roadway along the traveling direction of the pedestrian, through map-matching a position of the pedestrian measured at reception times based on the satellite signal received from each of the plurality of satellites to any of links configuring a walking route network, wherein the route determiner determines the walking route through map-matching the position of the pedestrian measured at each of the reception times to either the first candidate or the second candidate selected through comparison between the environmental value of the left half side and the environmental value of the right half side.

13. The walking route determination method according to claim 10, wherein the environmental value determiner determines the environmental value using a value indicating whether a line of sight of each of the plurality of satellites as seen from the pedestrian is good or bad.

14. The walking route determination method according to claim 12, further comprising:
determining, by a traveling direction determiner, the traveling direction of the pedestrian based on a sign of a determined value based on an inner product of a direction of the positioning apparatus obtained from positioning results of the pedestrian at consecutive reception times and a direction of a link determined as the first candidate or the second candidate.

15. The walking route determination method according to claim 12, further comprising:
determining, by a section determiner, sections using, as a boundary, a timing at which links as the first candidate and the second candidate determined by the candidate determiner change simultaneously, wherein the environmental value determiner determines the environmental value of the left half side and the environmental value of the right half side for each of the sections determined by the section determiner, and the route determiner determines the walking route for each of the sections determined by the section determiner.

16. The computer-readable non-transitory recording medium according to claim 8, wherein the environmental value determiner determines the environmental value using a value indicating whether a line of sight of each of the plurality of satellites as seen from the pedestrian is good or bad.

17. The computer-readable non-transitory recording medium according to claim 8, wherein the environmental value determiner determines the environmental value using a value indicating whether a line of sight of each of the plurality of satellites as seen from the pedestrian is good or bad.

18. The computer-readable non-transitory recording medium according to claim 8, the computer-executable instructions when executed further causing the system to:
determine, by a candidate determiner, a first candidate and a second candidate of a walking route, the first candidate and the second candidate being positioned to face each other in relation to a roadway along the traveling direction of the pedestrian, through map-matching a position of the pedestrian measured at reception times based on the satellite signal received from each of the plurality of satellites to any of links configuring a walking route network, wherein the route determiner determines the walking route through map-matching the position of the pedestrian measured at each of the reception times to either the first candidate or the second candidate selected through comparison between the environmental value of the left half side and the environmental value of the right half side.

19. The computer-readable non-transitory recording medium according to claim 16, wherein the environmental value determiner determines the environmental value using a value indicating whether a line of sight of each of the plurality of satellites as seen from the pedestrian is good or bad.

20. The computer-readable non-transitory recording medium according to claim 18, the computer-executable instructions when executed further causing the system to:
determine, by a traveling direction determiner, the traveling direction of the pedestrian based on a sign of a determined value based on an inner product of a direction of the positioning apparatus obtained from positioning results of the pedestrian at consecutive reception times and a direction of a link determined as the first candidate or the second candidate.
